(19) United States
(12) Patent Application Publication
(10) Pub. No.: US 2013/0162391 A1
(43) Pub. Date: Jun. 27, 2013

(54) COMMUNICATION DEVICE FOR THE VISUALLY IMPAIRED AND NUMBER INPUT METHOD

(71) Applicants: Fu Tai Hua Industry (Shenzhen) Co., Ltd., Shenzhen (CN); Hon Hai Precision Industry Co., Ltd., New Taipei (TW)

(72) Inventors: KAI-GUI WANG, Shenzhen (CN); HUA-LIN LV, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/716,389

(22) Filed: Dec. 17, 2012

(30) Foreign Application Priority Data
Dec. 24, 2011 (CN) 201110438402.6

(51) Int. Cl. G09B 21/00

(52) U.S. Cl. CPC G09B 21/006
USPC 340/4.13; 340/4.1; 340/4.14

(57) ABSTRACT

A computerized method for inputting numbers 0-9 using a communication device, the communication device includes an input unit defining a touch sensitive circular guideway thereon configured for inputting the numbers 0-9. The circular guideway is divided into a plurality of identical segments. A movement distance of a slide action applied on the circular guideway along a predetermined direction from a predetermined starting point on the circular guideway is detected. An inputted number is determined according to the movement distance of the slide action and a length of each of the segments, when the slide action on the circular guideway is completed.

### BACKGROUND

1. Technical Field

Embodiments of the present disclosure relate to communication devices, and in particular, to a number input method of a communication device.

2. Description of Related Art

Many communication devices, such as corded telephones and mobile phones, usually comprise a keyboard as an input device. Numbers and letters may be printed on buttons of the keyboard to guide a user to input information. However, such input device is difficult for those who are visually impaired.

### BRIEF DESCRIPTION OF THE DRAWINGS

FIG. 1 is a block diagram illustrating one embodiment of a communication device.

FIG. 2 is a schematic diagram of an example of the communication device of FIG. 1 including a plurality of components.

FIG. 3 is a cross-sectional view of a notification portion of an input unit of the communication device along a VI-VI line of FIG. 2.

FIG. 4 shows a touch switch defined under the notification portion of FIG. 3 according to another embodiment.

FIG. 5 is a flowchart of one embodiment of a number input method of the communication device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

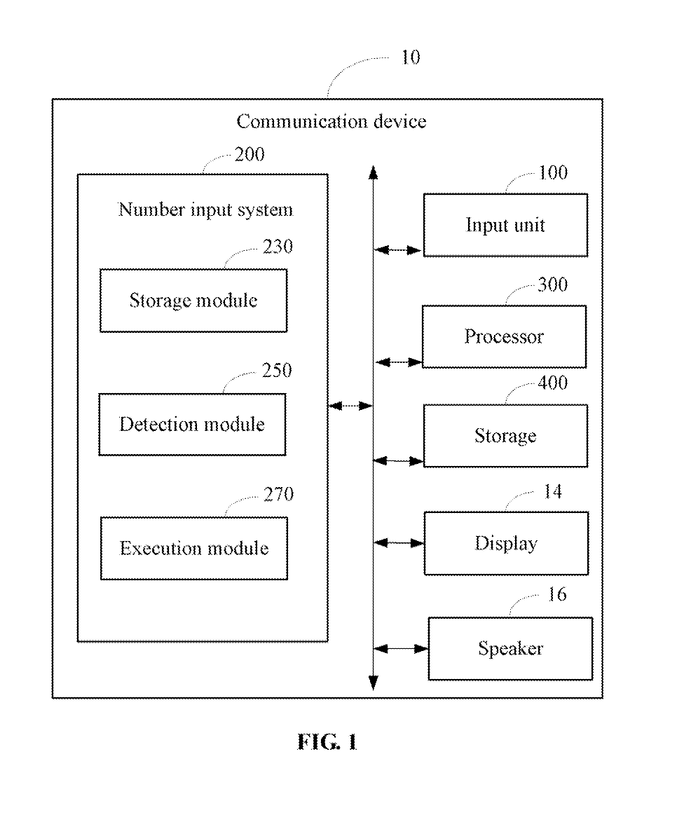

FIG. 1 is a schematic block diagram illustrating one embodiment of a communication device 10 The communication device 10 includes an input unit 100, a number input system 200, a processor 300, a storage 400, a display 14, and a speaker 16. The communication device 10 may be, for example, a mobile phone, a corded telephone, or other similar device. FIG. 1 shows one example of the communication device 10, and the communication device 10 can include more or fewer components than those shown in the embodiment, or have a different configuration of the components.

The input unit 100 may be a touch unit, such as a touch panel. The input unit 100 defines a touch sensitive circular guideway thereon configured for inputting numbers 0-9. A user can input any of the numbers 0-9 using a finger to slide along the circular guideway in a predetermined direction (e.g., a clockwise direction). The number input system 200 detects the slide action of the user on the circular guideway, to realize the number input function of the communication device 10 using the input device 100. In other embodiments, the input unit 100 may be a rotatable dial.

The number input system 200 may include a plurality of programs in the form of one or more computerized instructions stored in the storage 400 and executed by the processor 300 to perform operations of the communication device 10. In the embodiment, the number input system 200 includes a storage module 230, a detection module 250, and an execution module 270. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

The detection module 250 detects a movement distance of a slide action applied on the circular guideway, for example a slide action along the predetermined direction from a predetermined starting point on the circular guideway. In the embodiment, the user may use a finger or a stylus to slide along the circular guideway to input one or more numbers.

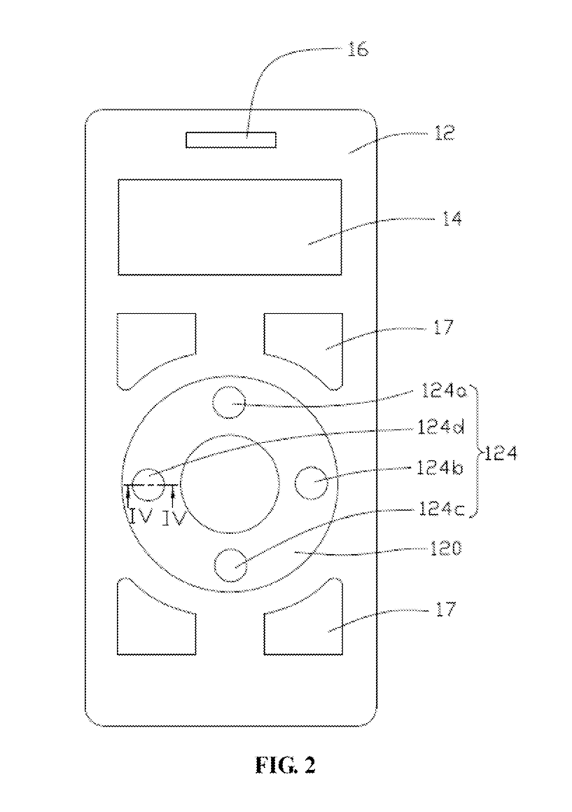

When the slide action on the circular guideway is completed, the execution module 270 determines an inputted number according to the movement distance of the slide action. In the embodiment, the circular guideway defines a plurality of notification portions 124 (see FIG. 2, 124a, 124b, 124c, 124d) which are slightly protrusive from the circular guideway. The circular guideway is divided into a plurality of identical segments by the notification portions 124. In one example, as shown in FIG. 2, the circular guideway is defined on a body 12 of the communication device 10 and labeled as 120. The circular guideway 120 is divided into four segments by the notification portions 124a, 124b, 124c, and 124d. The four segments respectively are 124a to 124b, 124b to 124c, 124c to 124d, and 124d to 124a. The notification portion 124a may be predetermined as the starting point. A ratio of the movement distance of the slide action to a length of each of the segments is determined to be the inputted number. In other words, a count of the touched segments are related the corresponding inputted number. For example, if the movement distance is equal to two and ¼ laps of the circular guideway, “9” is determined to be the inputted number of the slide action. If the movement distance is equal to three over four lap of the circular guideway, “3” is determined to be the inputted number of the slide action. If the movement distance is less than a length of any of the segments, “0” is determined to be the inputted number. The user can complete the slide action by pressing any of the notification portions 124 for a predetermined time period (e.g., one or two seconds) or double tapping the input unit 100.

The storage module 230 may store each of the numbers 0-9 corresponding to a movement distance in a table for example as shown below. The table is prestored in the storage 400. The detection module 250 further determines a number corresponding to the movement distance of the slide action according to the table when the slide action slides to any of the notification portions 124, and plays a predetermined audio indicating the number corresponding to the movement distance of the slide action through the speaker 16. Thus, the user who is visually impaired can precisely input a desired number by sliding something (e.g., fingertip or stylus) along the circular guideway according to the notification of the speaker 16. When the slide action is completed, the inputted number may be displayed on the display 14, and the execution module 270 further plays a predetermined audio indicating which of the numbers 0-9 has been inputted through the speaker 16.

| Movement distance | |
|---|---|
| (lap) | Number |
| 0 | 0 |
| ¼ | 1 |
| 2/4 | 2 |
| ¾ | 3 |
| One | 4 |
| One and ¼ | 5 |
| One and 2/4 | 6 |
| One and ¾ | 7 |
| Two | 8 |
| Two and ¼ | 9 |

As shown in FIG. 2, the communication device 10 further includes a plurality of function buttons 17 such as a call button, a hang up button, a backspace button, and a main menu button. The user can press the call button to make a call when a target phone number is inputted using the input unit 100. Each of the function buttons 17 protrudes from the body 12 of the communication device 10 to facilitate operation of users who are visually impaired.

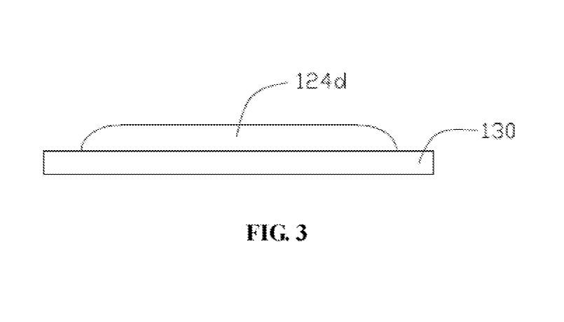

In the embodiment, the input unit 100 further includes a touch sensing unit 130 (e.g., a capacitive touch sensor) defined under the circular guideway 120, which is configured for sensing the slide action of the user. For example, as shown in FIG. 3, a cross-sectional view of a notification portion 124d along the line of VI-VI of FIG. 2. The detection unit 250 detects the movement distance of the slide action using the touch sensing unit 130. The user may signal the end of the slide action by double tapping any position of the circular guideway 120. Alternatively, the user may signal the end of the slide action by pressing the notification portion 124d using his/her finger or a stylus for the predetermined time period. In one embodiment, the circular guideway 120 may be an annular groove or an annular protrusion.

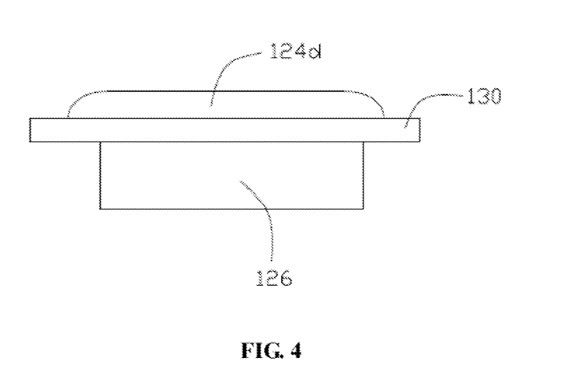

In another embodiment, as shown in FIG. 4, the input unit 100 further includes a plurality of touch switches 126 defined under each of the notification portions 124. One end of each of the touch switches 126 is connected to one of the notification portions 124, and another end of each of the touch switches 126 is connected to a power supply unit of the communication device 10. When a user wants to complete the slide action, the user can press any of the notification portions 124 to turn on a corresponding touch switch 126. Thus, a voltage signal is outputted to the input unit 100 through the touch switch 126, so that the detection unit 250 can detect whether the slide action is completed according to the voltage signal.

In use of the communication device 10, numbers can be precisely inputted through the circular guideway of the communication device 10 without watching the input unit 100, thereby facilitating those who are visually impaired.

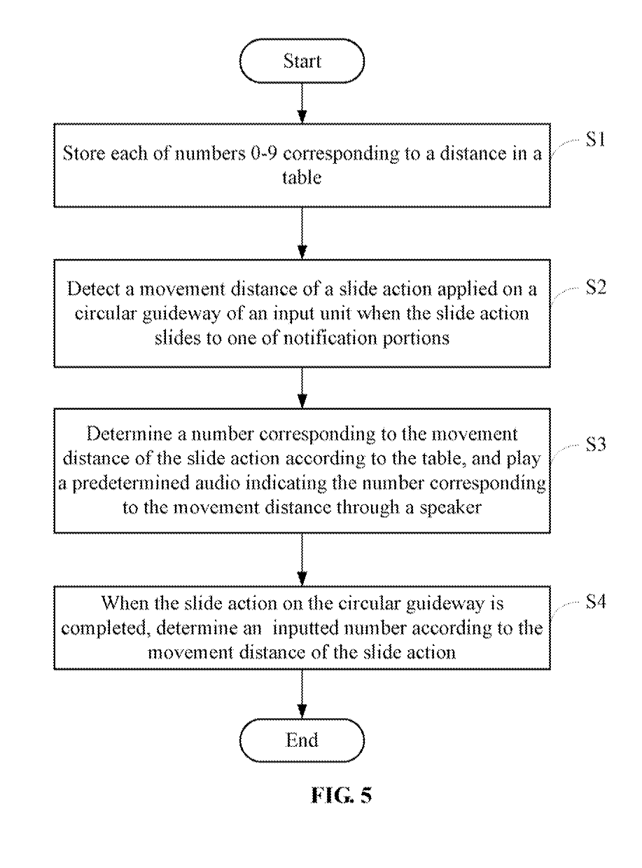

FIG. 5 shows a flowchart of one embodiment of a number input method of the communication device 10 of FIG. 1. Depending on the embodiment, additional steps may be added, others removed, and the ordering of the steps may be changed.

In step S1, the storage module 230 stores each of numbers 0-9 corresponding to a distance in a table prestored in the storage 400.

In step S2, the detection module 250 detects a movement distance of a slide action on the circular guideway of the input unit 100 at any time when the slide action slides to one of the notification portions 124.

In step S3, the detection module 250 determines a number corresponding to the movement distance of the slide action according to the table, and plays a predetermined audio indicating the number corresponding to the movement distance of the slide action through the speaker 16.

In step S4, when the slide action on the circular guideway is completed, the execution module 270 determines an inputted number according to the movement distance of the slide action.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device, comprising:
an input unit defining a touch sensitive circular guideway thereon, which is configured for inputting numbers 0-9, the circular guideway being divided into a plurality of identical segments;
a storage;
a processor; and
one or more programs stored in the storage and executed by the processor, the one or more programs comprising:
a detection module that detects a movement distance of a slide action applied on the circular guideway along a predetermined direction from a predetermined starting point on the circular guideway; and
an execution module that determines an inputted number according to the movement distance of the slide action and a length of each of the segments, when the slide action on the circular guideway is completed.

2. The communication device according to claim 1, wherein the circular guideway defines a plurality of notification portions which protrude from the circular guideway, and the circular guideway is divided into the plurality of identical segments by the notification portions.

3. The communication device according to claim 2, wherein a ratio of the movement distance of the slide action to a length of each of the segments is defined to be the inputted number.

4. The communication device according to claim 2, wherein one of the notification portions is defined as the starting point.

5. The communication device according to claim 2, wherein the one or more programs further comprise:
a storage module that stores each of the numbers 0-9 corresponding to a movement distance in a table prestored in the storage.

6. The communication device according to claim 5, wherein the detection module further determines a number corresponding to the movement distance of the slide action according to the table when the slide action slides to any of the notification portions, and plays a predetermined audio indicating the number corresponding to the movement distance of the slide action through a speaker of the communication device.

7. The communication device according to claim 6, wherein the inputted number is displayed on a display of the communication device, and the execution module further plays a predetermined audio indicating which of the numbers 0-9 has been inputted through the speaker.

8. The communication device according to claim 1, wherein the circular guideway is an annular groove or an annular protrusion.

9. The communication device according to claim 2, wherein the input unit further includes a touch sensing unit defined under the circular guideway and configured for sensing the slide action, and the slide action is completed by double tapping any position of the circular guideway.

10. The communication device according to claim 2, wherein the input unit further includes a plurality of touch switches, each of the touch switches is connected to one of the notification portions, and the slide action is completed by pressing any of the notification portions for a predetermined time period.

11. A number input method of a communication device, the communication device comprising an input unit defining a touch sensitive circular guideway thereon configured for inputting numbers 0-9, the circular guideway being divided into a plurality of identical segments, the method comprising:
detecting a movement distance of a slide action applied on the circular guideway along a predetermined direction from a predetermined starting point on the circular guideway; and
determining an inputted number according to the movement distance of the slide action and a length of each of the segments, when the slide action on the circular guideway is completed.

12. The method according to claim 11, wherein the circular guideway defines a plurality of notification portions which protrude from the circular guideway, and the circular guideway is divided into the plurality of identical segments by the notification portions.

13. The method according to claim 12, wherein a ratio of the movement distance of the slide action to a length of each of the segments is defined to be the inputted number.

14. The method according to claim 12, wherein one of the notification portions is defined as the starting point.

15. The method according to claim 12, further comprising:
storing each of the numbers 0-9 corresponding to a movement distance in a table prestored in a storage of the communication device.

16. The method according to claim 15, wherein the detecting step comprises:
determining a number corresponding to the movement distance of the slide action according to the table, when the slide action slides to any of the notification portions; and
playing a predetermined audio indicating the number corresponding to the movement distance of the slide action through a speaker of the communication device.

17. The method according to claim 16, wherein the inputted number is displayed on a display of the communication device, and the determining step comprises:
playing a predetermined audio indicating which of the numbers 0-9 has been inputted through the speaker.

18. The method according to claim 11, wherein the circular guideway is an annular groove or an annular protrusion.

19. The method according to claim 12, wherein the input unit further includes a touch sensing unit configured for sensing the slide action and defined under the circular guideway, and the slide action is completed by double tapping any position of the circular guideway.

20. The method according to claim 12, wherein the input unit further includes a plurality of touch switches, each of the touch switches is connected to one of the notification portions, and the slide action is completed by pressing any of the notification portions for a predetermined time period.
